(19) United States
(12) Patent Application Publication
(10) Pub. No.: US 2007/0176379 A1
(43) Pub. Date: Aug. 2, 2007

(54) Shopping cart or transport container

(76) Inventors: Horst Sonnendorfer, Puchheim (DE); Franz Wieth, Puchheim (DE)

Correspondence Address: LERNER GREENBERG STEMER LLP, P O BOX 2480, HOLLYWOOD, FL, 33022-2480, US

(21) Appl. No.: 10/589,588

(22) PCT Filed: Feb. 16, 2005
(86) PCT No.: PCT/DE05/00264

§ 371 Date: Aug. 16, 2006

(30) Foreign Application Priority Data
Feb. 16, 2004 (DE) 20 2004 002 438.1

(51) Int. Cl. B62D 39/00

(52) U.S. Cl. 280/33.991

(57) ABSTRACT

A shopping cart or transport container includes a combined hydrophobic or superhydrophobic and/or ion-releasing surface. The shopping cart or transport container therefore does not provide an environment that permits the survival of pathogens.

The invention relates to a shopping cart or transport container in its broadest sense.

A large proportion of the shopping carts or transport containers in use have a surface made of zinc-plated, chrome-plated or painted metal. The so-called basket, that is to say the region in which the transported items, for example the purchased goods, are placed, consists of an interwoven structure of round metal bars. There are a small number of plastic shopping carts in existence. To achieve a sufficient degree of stability for the basket, the basket consists of plastic bars which are more solid than the metal bars.

As a result of use, shopping trolleys or transport containers are subject to soiling, making cleaning necessary at certain intervals.

For reasons of food hygiene regulations, shopping carts or transport containers in which foods is transported must be cleaned only with water without the addition of solvents. To increase the cleaning action of the water, the water is sprayed at a high temperature onto the regions to be cleaned using so-called steam jets. Depending on the degree and nature of the soiling, mechanical assistance in the form of brushing is additionally required.

On the one hand, this cleaning method requires a high degree of effort; on the other hand, this method achieves the desired result only when the cleaning is performed on shopping carts or transport containers made of metal. In the case of shopping carts or transport containers made of plastic, the conditions for cleaning are even more difficult since there are crevices at the junction points between the individual plastic bars and contaminating matter becomes deposited therein. The fact that the bars in plastic shopping carts are more solid than the metal bars results in long crevices. When cleaning plastic shopping carts or transport containers, these long crevices at the junction points between the bars again require special cleaning, which further increases the effort involved.

It is an object of the invention to provide a shopping cart or transport container made of metal or plastic in which the cleaning effort is reduced and/or the surface does not offer an environment in which bacteria and/or fungi and their spores can take hold and/or multiply.

This object is achieved by the characterizing features of claim 1.

The underlying consideration was that a hydrophobic surface of the shopping cart or transport container, this surface additionally having a so-called nanostructure, in most cases does not give the contaminating matter sufficient purchase to adhere firmly. Such a surface then has so-called superhydrophobic properties.

Contaminating matter which nevertheless remains clinging to the dry surface can then be removed easily and virtually without trace with normal running water. The water itself here drips off the surface virtually without trace and in the process takes up the contaminating matter adhering to the surface and transports this matter away.

Such a surface is described in WO 96/04123 and can be used in a novel and inventive way to reduce the cleaning effort required for shopping carts.

With regard to shopping carts having a basket made of plastic, an economically expedient use in the food sector is possible for the first time, since it is only with the present invention that the specific problem of firmly adhering dirt in the corners of the bar junction points is eliminated.

If the shopping cart is exposed to rain, the cleaning is performed by the rainwater itself.

A further consideration was that pathogens such as fungi or bacteria which adhere to a shopping cart can be transferred from there to food situated within such a shopping cart.

For fungi to be able to develop, the fungal spores must first germinate. The fungal spores require moisture for this germination. Here, as a result of its additional nanostructure, the hydrophobic or superhydrophobic surface in a shopping cart according to the invention has a twofold action against pathogens. The pathogens or fungal spores are washed off during each cleaning operation or by rainwater, and since all the water runs off from the surface of the shopping cart without a trace, the moist environment necessary for germination or survival is not available to pathogens.

At the same time, fungal spores which have adhered to the dry surface are taken along by the water running off and removed from the surface.

The use of a surface having ion-releasing properties makes it possible to kill any bacteria.

The use according to the invention of the combined hydrophobic or superhydrophobic and/or ion-releasing surface results in a shopping cart having the additional property of not providing an environment in which pathogens can survive.

The invention will be explained below with reference to two drawings.

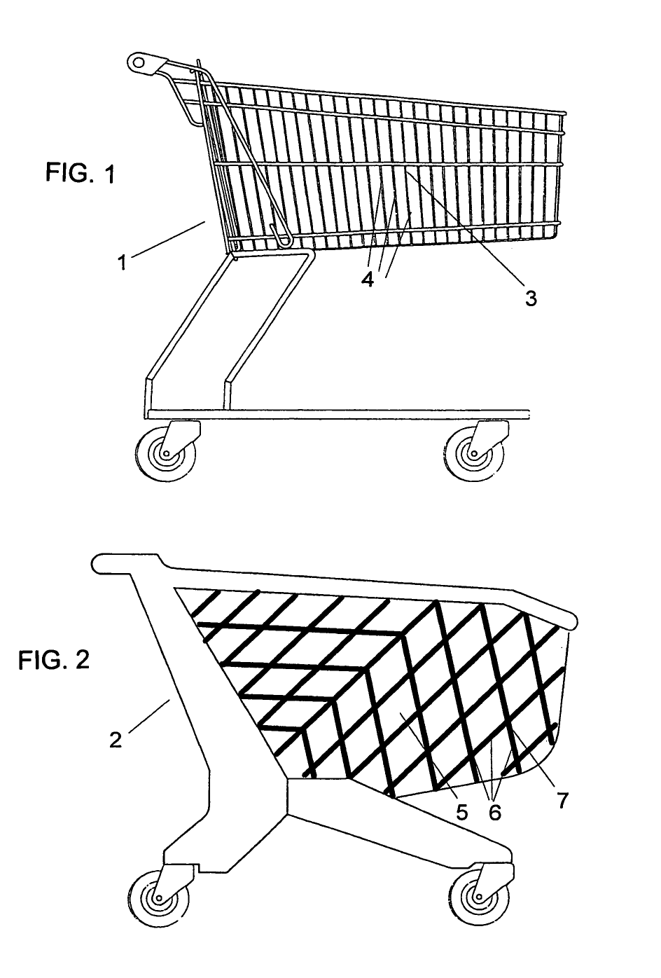

FIG. 1. shows a customary shopping cart made of steel, and

FIG. 2 shows a shopping cart made of plastic.

In the case of both shopping carts 1, 2, the surface is designed to be hydrophobic or superhydrophobic and/or ion-releasing.

The hydrophobic or superhydrophobic and/or ion-releasing property of the surface can be achieved in the case of the steel shopping cart by coating with an appropriate material.

This coating may be applied to the shopping cart either during the primary production process or at a later time, for example during an overhaul.

It is preferable for only the basket 3, which consists of a multitude of metal bars 4, to be equipped with a hydrophobic or superhydrophobic and/or ion-releasing surface. The remaining regions of the shopping cart which cannot come into contact with the food remain without a specially treated surface.

In the case of the plastic shopping cart 2, the hydrophobic or superhydrophobic and/or ion-releasing surface may have already been produced by appropriate production methods.

In the case of conventionally produced plastic shopping carts, that is to say ones produced without a hydrophobic or superhydrophobic and/or ion-releasing surface, a subsequent coating is possible.

The basket 5 of the shopping cart 2 consists of comparatively solid bars 6.

At the junction points of a number of bars 6 (exemplified by 7 in the example shown), there are angled regions at the transitions to the bars, in which regions contaminating matter stubbornly settles in the case of normal surfaces. It is precisely in these regions that the hydrophobic or superhydrophobic and/or ion-releasing surface according to the invention is particularly advantageous.

The invention can be applied to any type of transport container in which the easy cleaning of contaminating matter provides an advantage. Examples of such transport containers are cases, baskets or folding boxes used particularly for food shopping or storage.

The advantages of easy cleaning can equally also be applied to all other sectors in which transport containers are liable to soiling and are then intended to be easy to clean again.

1-4. (canceled)

5. A shopping cart or transport container, comprising:
a surface composed completely or partially of at least one material selected from the group consisting of hydrophobic material, superhydrophobic material and ion-releasing material.

6. The shopping cart or transport container according to claim 5, wherein said surface additionally includes a nanostructure.

7. The shopping cart or transport container according to claim 5, wherein said surface is formed during production of the shopping cart or transport container.

8. The shopping cart or transport container according to claim 6, wherein said surface is formed during production of the shopping cart or transport container.

9. The shopping cart or transport container according to claim 5, wherein the surface is formed by subsequent treatment of an existing shopping cart or transport container.

10. The shopping cart or transport container according to claim 6, wherein the surface is formed by subsequent treatment of an existing shopping cart or transport container.

11. A method for manufacturing a shopping cart or transport container, the method comprising the following steps:
providing a shopping cart or transport container having a surface; and
forming the surface completely or partially of at least one material selected from the group consisting of hydrophobic material, superhydrophobic material and ion-releasing material.

12. The method according to claim 11, which further comprises additionally adding a nanostructure to the surface.

13. The method according to claim 11, which further comprises forming the surface during production of the shopping cart or transport container.

14. The method according to claim 12, which further comprises forming the surface during production of the shopping cart or transport container.

15. The method according to claim 11, which further comprises forming the surface by subsequent treatment of an existing shopping cart or transport container.

16. The method according to claim 12, which further comprises forming the surface by subsequent treatment of an existing shopping cart or transport container.
